(19) United States
(12) Patent Application Publication
(10) Pub. No.: US 2010/0033908 A1
(43) Pub. Date: Feb. 11, 2010

(54) Power distribution unit configured for direct contact with leads

(75) Inventor: Darrell Leland Fernald, JR., Bradenton, FL (US)

Correspondence Address: KING & SPALDING, LLP, 1100 LOUISIANA ST., STE. 4000, ATTN.: IP Docketing, HOUSTON, TX, 77002-5213, US

(73) Assignee: COOPER TECHNOLOGIES COMPANY, Houston, TX (US)

(21) Appl. No.: 12/188,902

(22) Filed: Aug. 8, 2008

(51) Int. Cl. H02B 1/26; G08B 5/00; G08B 3/00

(52) U.S. Cl. 361/641; 340/815.4; 340/384.1

(57) ABSTRACT

A power distribution unit (PDU) configured to receive power from a multiple phase power source provides power for other devices in formats not previously available from PDUs. The PDU receives power in multiple phases and then separates the power into individual phases. The individual phases are then electrically coupled to separate output terminals. The output terminals then provide power to other devices in a format other than the original multiple phase format while maintaining safety features.

### TECHNICAL FIELD

The present application relates generally to power distribution units (PDUs). More particularly, the present application relates to PDUs that facilitate connections between multiple phase, electrical power inputs to single phase electrical power outputs.

### BACKGROUND

PDUs are widely used to distribute power from a power source to other devices. Typical PDUs transmit power in the same phase format if is received. Since most power sources generate power in three phases, typical PDUs receive and retransmit power in three phases. Three phase outputs are needed for large equipment, but are excessive for low power applications, such as lighting or air conditioning.

PDU users have resorted to after market measures to facilitate single phase power distribution. PDU users have learned how to bypass safety features and physically separate the three phase connectors in a PDU into a series of single phase connectors to provide power for single phase power applications. This bypass usually involves stripping away insulation and protective coverings to expose the needed phase connectors that are then directly connected to the electrical leads powering a device. A side effect of these types of after market modifications is the safety features of the; PDU cannot easily be reinstated as the wiring is now exposed. In the event all three phase connectors are not used, the unused phase connectors are also exposed. Any of these conditions lead to possible electrocution dangers.

Therefore, a need exists for a PDU that accepts power in multiple phases and directs the power to other devices in a single phase, while at me same time maintaining pre-existing safety features.

### SUMMARY

The present application relates generally to PDUs that, receive power in a multiple phase format and transmit power in a single phase format.

The PDU of the present invention receives power from a typical multiple phase power source. The power received is then divided among multiple output connectors with each output connector assigned to a different phase, with optional output connectors for neutral and ground phases. These output connectors may then be connected to electrical devices to supply power. Connectors coupled to the PDU may be of any type, but split stud connectors will be discussed in the exemplary embodiments.

The system of the present invention places a PDU inside a PDU enclosure. The use of the PDU enclosure provides an additional level of protection and facilitates the use of the PDU in various environments.

The method of the present invention receives multiple phase power inputs and converts them into a plurality of single phase power outputs.

These and other aspects, objects, and embodiments of the present invention will become apparent to those having ordinary skill in the art upon consideration of the following detailed description of illustrative embodiments exemplifying the best mode for carrying out the invention as presently perceived.

### BRIEF DESCRIPTION OF THE DRAWINGS

The present invention may be better understood by reading the following description of non-limitative, exemplary embodiments; with reference to the attached drawings, wherein like parts of each of the Figures are identified by the same reference characters, and which are briefly described as follows.

FIG. 1 is a block diagram illustrating an overview of power flow through a power distribution unit in the exemplary embodiment.

FIG. 2 is a perspective view of the output side of the power distribution unit of FIG. 1 according to an exemplary embodiment.

FIG. 3A is a schematic view of a split stud connector utilized by the power distribution unit of FIG. 1 according to an exemplary embodiment.

FIG. 3B is side view of a sliding ferrule utilized by the split stud connector of FIG. 3A according to an exemplary embodiment.

FIG. 3C is top down view of the sliding ferrule from FIG. 3B utilized by the split stud connector of FIG. 3A according to an exemplary embodiment.

FIG. 4A is a perspective view of the insulator board from FIG. 2.

FIGS. 4B-C are schematic views of a spacer utilized by the split stud connector of FIG. 3A according to an exemplary embodiment.

FIGS. 4D-E are schematic views of an insulator utilized by the split stud connector of FIG. 3a according to an exemplary embodiment.

FIG. 5 is a schematic view of the split stud connector of FIG. 3A utilizing the sliding ferrule of FIG. 3B, the spacer of FIG. 4A, and insulator of FIG. 4B according to an exemplary embodiment including a representation of the positioning of the nut, the external power source, and the equipment with respect to the split stud connector.

FIG. 6 is an input side view of a power distribution unit enclosure having the external contact exposed according to an exemplary embodiment.

FIG. 7 is a perspective view of the output side of the power distribution unit enclosure of FIG. 6 according to an exemplary embodiment.

FIG. 8 is a block diagram view of a power distribution unit enclosure illustrating the connection between the external connections, the power distribution unit, output connectors, and electrical leads according to an exemplary embodiment.

FIG. 9 is a perspective view of a power distribution unit incorporated with a generator according to an exemplary embodiment.

FIG. 10 is a perspective view of a power distribution unit enclosure attached to a generator according to an exemplary embodiment.

FIG. 11 is a perspective view a power distribution unit enclosure with attached wheels according to an exemplary embodiment.

FIG. 12 is a perspective view of a power distribution unit enclosure with removable legs according to an exemplary embodiment.

FIG. 13 is a perspective, view of a power distribution unit enclosure stacked on top of another according to an exemplary embodiment.

FIG. 14 is a flowchart of the method utilized by the power distribution unit according to an exemplary embodiment.

### DETAILED DESCRIPTION OF THE EXEMPLARY EMBODIMENTS

The invention provides a power distribution unit (PDU) that allows power received in one format to be distributed to other devices in the same format or in an alternative format. The disclosed PDU provides a means of distributing power to electrical devices in different electrical formats that incorporates previously unavailable safety features.

The exemplary embodiment of this invention facilitates the receipt of three phase electrical power and distributes power in a single phase or multiple phases. It should be understood at the outset that although exemplary embodiments of the invention are illustrated below; the present invention may be practiced using any number of techniques, whether currently known or in existence; The present invention should not be limited to the exemplary implementation, drawings, and techniques illustrated below, including the exemplary design and implementation illustrated and described herein.

An advantage of the invention comes from the ability to convert multiple phase power provided by an external power source to single phase power distributed by the PDU. The PDU in an exemplary embodiment can power devices such as lights and air conditioning, which may utilize single phase power. Other phase conversions are possible without departing from the scope and sprit of the invention.

Power Distribution Unit (PDU)

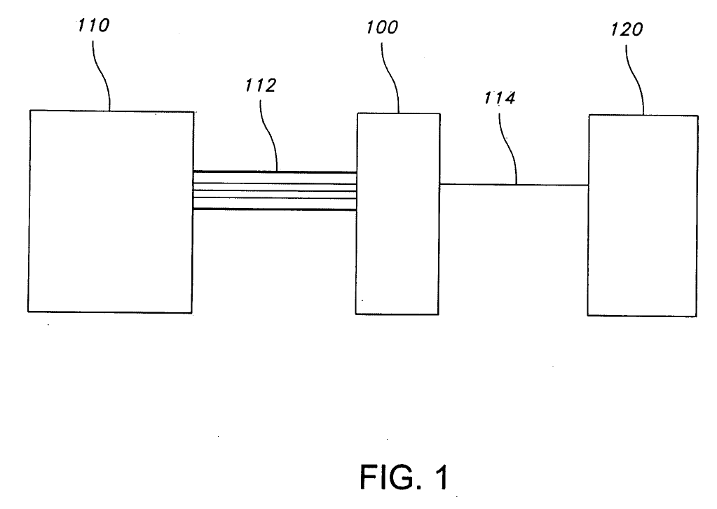

FIG. 1 is a block diagram illustrating an overview of power flow through a PDU 100 in an exemplary embodiment. Power is received in three phases from an external power source 110, which may be electrically coupled to the PDU 100 via a cable 112. Once received by the PDU 100, the power is divided into separate phases. A single power phase may then be supplied to the equipment 120 to be powered through an electrical lead 114.

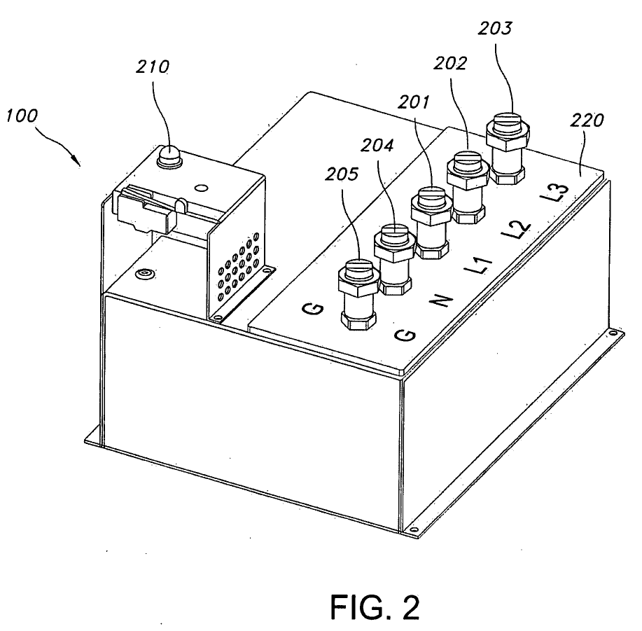

FIG. 2 is a perspective view of the output side of a PDU 100 of FIG. 1 according to an exemplary embodiment. The PDU 100 contains output connectors (L1 201, L2 202, L3 203, neutral 204, ground 205) that fasten to electrical leads 114 of equipment 120. The output connectors 201-205 pass through an insulator board 220 fastened to the outer casing of the PDU 100. The output connectors may be in accordance with I.A.W. MS39347-4 and may be color coded to identify each connection. Multiple electrical leads 114 may be connected to each output connector (201, 202, 203, 204, 205).

Referring to FIG. 1, the PDU 100 receives power in multiple phases from the power source 100 via a cable 112. The cable 112 contains five individual phase connections corresponding to a ground phase, a neutral phase, and three individual power phases. Once the power is received by the PDU 100, the various power phases are separated within the PDU 100 and are electrically coupled to the various output connectors (201, 202, 203, 204, and 205).

The PDU 100 may further comprise an indicator light 210, which indicates if the PDU 100 is receiving power from an external power source 110. This safety feature alerts a user to a possible electrocution danger by giving the user a visual warning that the PDU 100 is receiving electrical current.

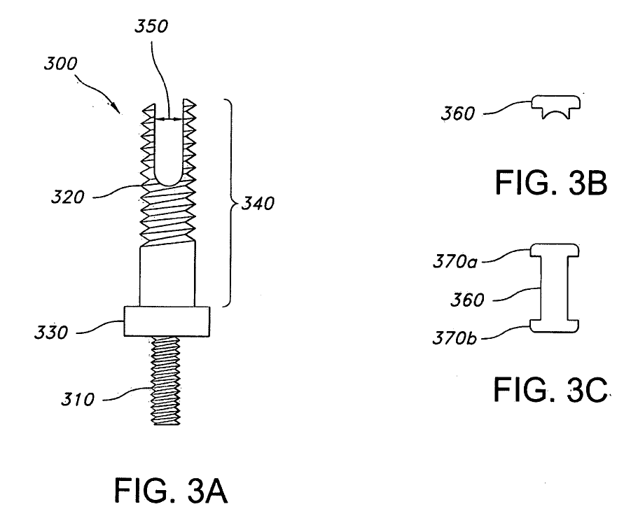

FIG. 3A is a schematic view of a split stud connector 300 utilized by the PDU 100 of FIG. 1 according to an exemplary embodiment. Such a split stud connector 300 may be used for the previously disclosed output connectors (201, 202, 203, 204, 205). The split stud connector 300 comprises a first threaded portion 310 that secures to the interior of the PDU 100. According to an exemplary embodiment, the first threaded portion 310 is electrically coupled to the external power source 110 though the first threaded portion's 310 contact with the PDU 100. In an exemplary embodiment, such an electrical connection may be made by a connection between a phase connector from the cable 112 to the first threaded portion 310. The first threaded portion 310 terminates at a head 330, which has a greater diameter than the first threaded portion 310. Extending from the head 330 opposite from the first threaded portion 310 is a second portion 340, which includes a second threaded portion 320. The second threaded portion 320 has a smaller diameter than the head 330. The second threaded portion 320 comprises a cavity 350 that extends across the diameter of the second threaded portion 320 and that terminates before the second threaded portion 320 ends. This cavity 350 removes a section of the second threaded portion 320 but maintains the threads, such that a nut may be fastened to the second threaded portion 320.

FIG. 3B is side view of a sliding ferrule 360 utilized by the split stud connector 300 from FIG. 3A according to an exemplary embodiment. FIG. 3C is a top down view of the sliding ferrule 360 from FIG. 3B utilized by the split stud connector 300 from FIG. 3A according to an exemplary embodiment Referring to FIG. 3B, the sliding ferrule 360 interacts with the cavity 350 of the split stud connector 300 described above. The sliding ferrule 360 can be inserted into the cavity 350 to constrict the cavity 350. In an exemplary embodiment, the sliding ferrule 360 has a middle section that is designed to correspond with the cavity 350 with a compression fit that provides a secure connection between the electrical leads 114 and the split stud connector 300. Additionally, the sides of the sliding ferrule 360 have projections 370a-b that extend beyond the radius of the second threaded portion 320 in an exemplary embodiment.

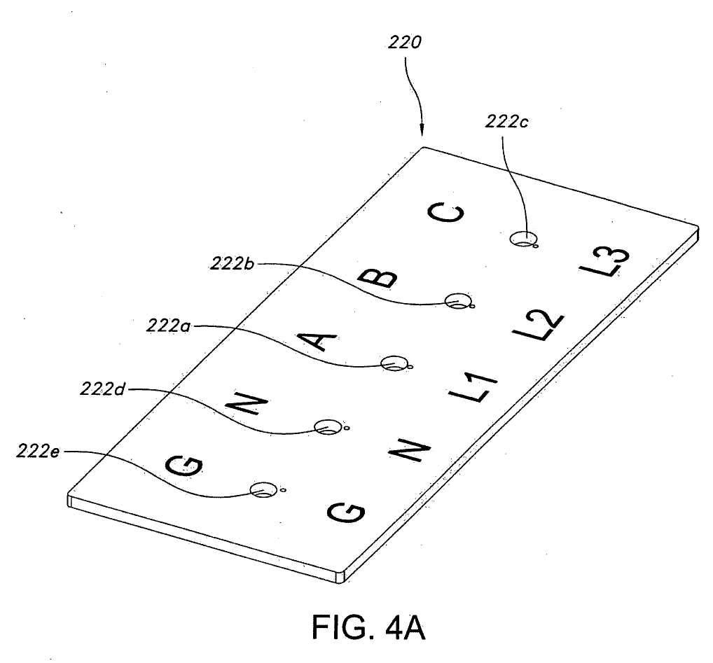

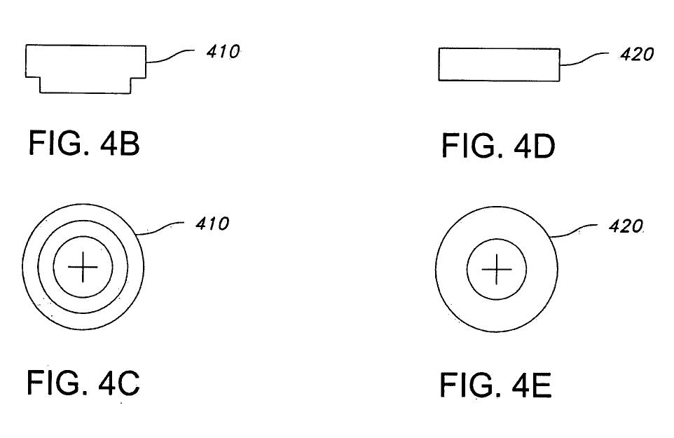

FIG. 4A is a perspective view of the insulator board 220 from FIG. 2. The insulator board 220 acts as a safety device to insulate the external surface of the PDU 100 from the current being received by the output connectors 201-205. The insulator board 220 comprises connector apertures 222a-e that the output connectors 201-205 pass through. The apertures 222a-e may be labeled for user reference. The insulator board 220 may be made out of any insulative material known to those skilled in the art

Alternative mechanisms for insulating the exterior surface of the PDU 100 are available. FIGS. 4B-C are schematic views of a spacer 410 utilized by the split stud connector 300 of FIG. 3A according to an exemplary embodiment. The spacer 410 acts as a buffer to separate the split stud connector 300 from the surface of the PDU 100. FIG. 4D-E are schematic views of an insulator 420 utilized by the split stud connector 300 of FIG. 3A according to an exemplary embodiment. The insulator 420 acts to prevent the power carried by the split stud connector 300 from electrifying a housing of the PDU 100.

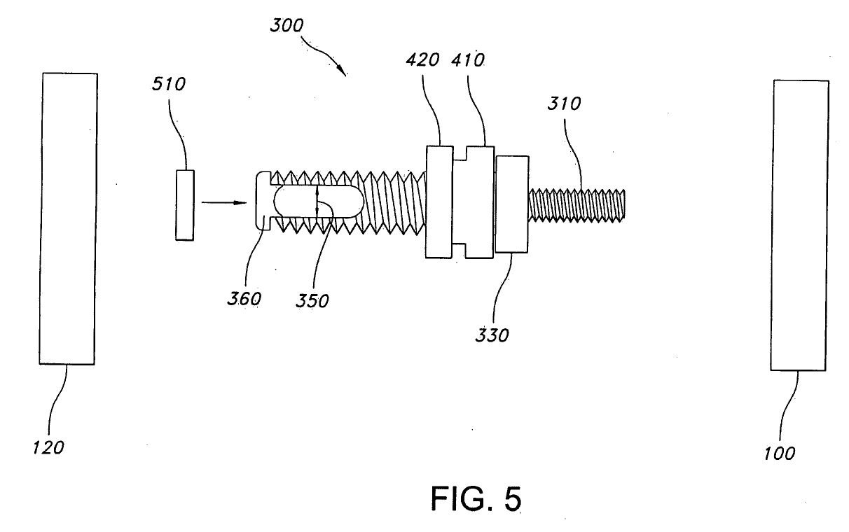

FIG. 5 is a schematic view of the split stud connector 300 illustrated in FIG. 3A utilizing the sliding ferrule 360 illustrated in FIG. 3B, the spacer 410 of FIG. 4A, and insulator 420 of FIG. 4B according to an exemplary embodiment. The first threaded portion 310 is exposed in the Figure, and would connect to the PDU 100 when installed. From the head 330 of the split stud connector 300, a spacer 410 is attached, and the insulator 420 attaches after the spacer. The cavity 350 in the second threaded portion 320 provides a means of securing the electrical leads 114 to the split stud connector 300. The portion of the cavity 350 where the electrical leads 114 are coupled is restricted by means of a restraining device. The device can take many forms. In the exemplary embodiment, a sliding ferrule 360 is used. The sliding ferrule 360 moves through the cavity 350 until the sliding ferrule 360 reaches a point where the electrical lead 114 is compressed in the cavity 350 by the sliding ferrule 360. After the sliding ferrule 360 is inserted in the cavity 350, a nut 510 with a threaded surface that is compatible with the second threaded portion 320 is coupled to the split stud connector 300. The sliding ferrule 360 is acted on by the nut 510 acting on the projections 370a-b of the sliding ferrule 360. With the sliding ferrule 360 secured by the nut 510, the electrical lead 114 (not shown for clarity) will be secured in the cavity 350 and the equipment 120. Once the electrical lead 114 is connected to the split stud connectors 300, the electrical lead 114 electrically couples the PDU 100 to the equipment 120.

The process discussed in FIG. 5 may be performed without the spacer 410 or insulator 420 according to an alternative embodiment. Alternative embodiments may replace the function of the spacer 410 and connector 420 with the previously discussed insulator board 220.

In an exemplary embodiment, the output connectors (201, 202, 203, 204, 205) are external to the PDU 100 and the first threaded portion 310 is coupled to the PDU 100 provided the first threaded portion 310 can enter to the PDU 100 though a threaded opening and receive power from the power source 110. The first threaded portion 310 conducts electricity to the second threaded portion 320 of the split stud connector 300 in order to distribute power. The second threaded portion 320 of the split stud connector 300 may be easily accessible to the user to allow electrical leads 114 to be fastened to the split stud connector 300.

The use of previously mentioned connectors (both conventional and the split stud connectors 300) is not limited to power output. The connectors may be used for either input or output. When used for power input, the connectors receive power from an external power source 110 to redistribute the power through output connectors (201, 202, 203, 204, 205). The input connectors,may be conventional connectors or the split stud connectors 300.

In the exemplary embodiment, the three power phases are distributed across a number of output connectors 201-205 to give an even distribution to the power load. A completed power circuit of each piece of equipment 120 to be powered may be created by connecting electrical leads 114 from the equipment 120 to a single phase output connectors (201, 202, 203) and to the neutral output connector 204. Alternative embodiments include electrical leads 114 connected to two of the single phase output connectors (201, 202, 203) and to the neutral output connector 204, making the resulting connection a dual phase connection. Alternatively, electrical leads 114 can be connected to three of the single phase output connectors (201, 202, 203) and to the neutral output connector 204, making the resulting connection a three phase connection. Further alternative embodiments of the PDU 100 may receive power from a single phase source, negating the need for a split of power from the power source 110.

As illustrated in FIG. 1, the PDU 100 distributes power received from an external power source 110 to equipment 120 connected to the PDU 100. In an exemplary embodiment, the PDU 100 receives power from an external power source 110 via a cable 112. Once the power is received by the PDU 100 from the external power source 110, the power is divided into separate power outputs. For example, if three phase power is received, then the first phase is connected to output connector L1 201, the second phase to output connector L2 202, and the third phase to output connector L3 203. This functionality allows a previously unavailable flexibility since previous PDUs transmitted power in the same format in which the power was received. The equipment 120 may use the PDU 100 to receive power in single phase, dual phase, or again in three phases, as desired. Alternatively, the PDU 100 may supply power to a secondary distribution center to provide additional flexibility in routing the power to the equipment 120.

PDU Enclosure

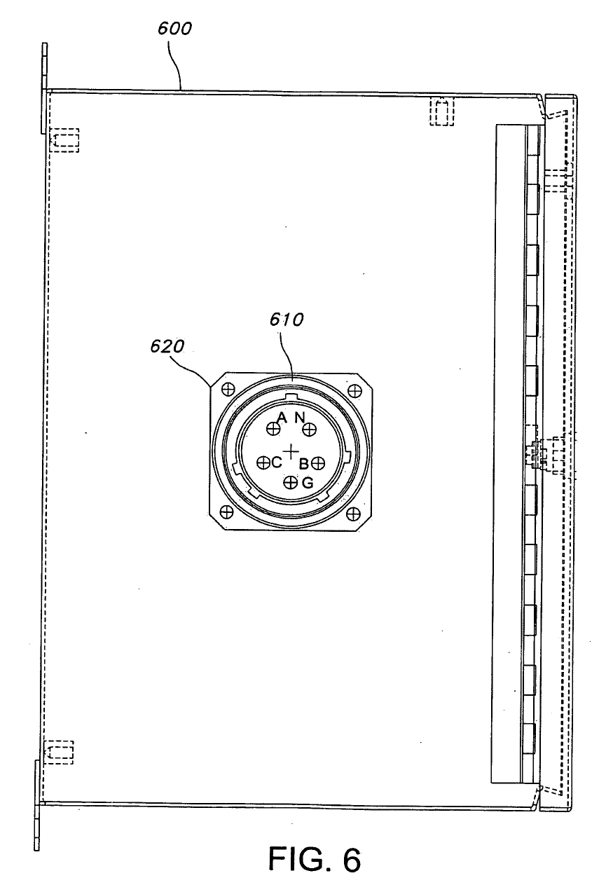

FIG. 6 is an input side view of a PDU enclosure 600 having an external connector 610 exposed according to an exemplary embodiment. The PDU 100 may be encased in the PDU enclosure 600 for safety reasons. In the exemplary embodiment, a typical five contact Type L 60 amp connector can be utilized as the external connector 610. Examples include a M22992 Class L connector in either a size thirty-two (32) for sixty (60) ampere input or a forty-four (44) size shell for one hundred (100) ampere input. An adapter plate 620 may be used to mount the thirty-two size (32) shell connector. The external connector 610 extends outside the PDU enclosure 600 and is easily accessible from outside the PDU enclosure 600. In the exemplary embodiment, the Type L connector has five elements that correspond to the output connectors (L1 201, L2 202, L3 203, neutral 204, and ground 205) of the PDU 100. As previously explained, the phase connectors of an external connection may be electrically coupled to the various output connecters 201-205 of the PDU 100. When not in use, a dust cover (not shown) may cover the external connector 610. Another form of input connector known to those skill in the art may be used.

As an additional safety feature, the PDU enclosure 600 may also comprise a grounding unit (not shown) to connect the PDU enclosure 600 to ground. The grounding unit may include a lock washer and a flat washer with a wing nut, via which a ground wire can be attached to the PDU enclosure 600.

FIG. 7 is a perspective view of the output side of the PDU enclosure 600 of FIG. 6 according to an exemplary embodiment. The output side of the PDU enclosure 600 comprises an aperture 710 having a covering 720 to protect the interior of the PDU enclosure 600. In an exemplary embodiment, the covering 720 may be fastened inside the PDU enclosure 600 and extend outside the PDU enclosure 600. The covering 720 may be attached to the PDU enclosure 600 by various means, including screws, adhesives, or other fasteners. In the exemplary embodiment, a rubberized canvas is used for the covering 720. This covering 720 is further modified by including a drawstring closure mechanism that allows the covering 720 to be secured around the electrical leads 114, preventing contaminants from entering or leaving the PDU enclosure 600 through the aperture 710.

The interior of the PDU enclosure 600 may be accessed by a lid 740. In the exemplary embodiment, the lid 740 is on the upper surface of the PDU enclosure 600 and would allow a user to directly access the PDU 100. In an exemplary embodiment, the user opens the lid 740 and threads electrical leads 114 through the aperture 710 into the PDU enclosure 600. Once the, electrical leads 114a-e are through the aperture 710, the user may then directly couple the electrical leads 114a-e to the various output connectors 201-205. Once the connections between the output connectors 201-205 and the electrical leads 114a-e are completed, the lid 740 may be closed to secure the PDU enclosure 600 while allowing the electrical leads 114a-e to pass though the aperture 710. The enclosure 600 further comprises a tab 730 that allows the user to open the lid 740 of the PDU enclosure 600. The tab 730 may be screwdriver activated means to keep the lid 740 secure while in use. Alternatively, the tab 730 may comprise a combination or key lock to control access to an interior of the enclosure 600.

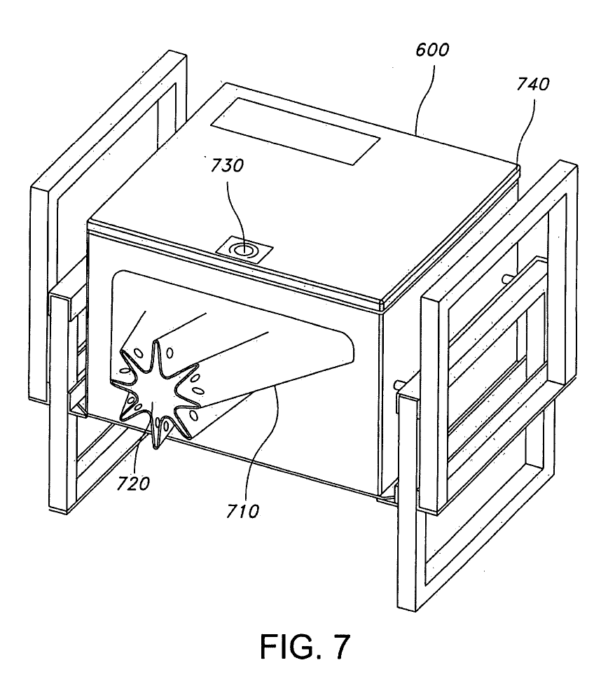

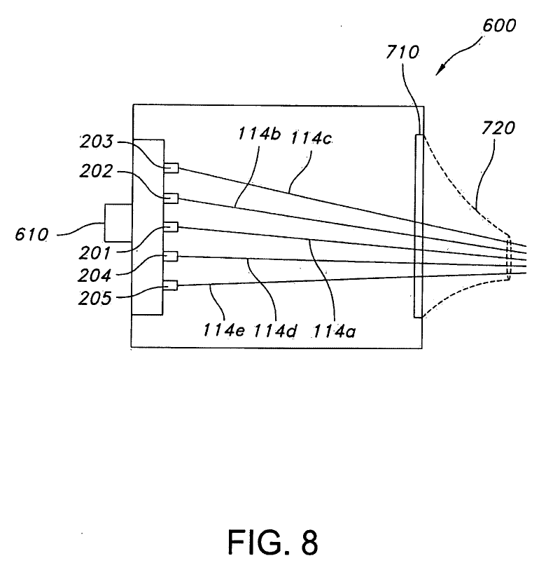

FIG. 8 is a diagram view of the PDU enclosure 600 of FIG. 6 illustrating the connections between the external connector 610, the PDU 100, the output connections (201, 202, 203, 204, 205), and the electrical leads; 114a-e according to an exemplary embodiment. An external power source 110 connects to the external connector 610, which is exposed to the outside of the PDU enclosure 600, and which is coupled to the PDU 100. The power received from the external power source 110 by the PDU 100 is separated into component single phases, neutral, and ground. These single phases, neutral, and ground are then distributed to the corresponding output connectors (201, 202, 203, 204, 205) as previously discussed. In the exemplary embodiment, the electrical leads 114a-e from the equipment 120 are connected to the corresponding output connectors (201, 202, 203, 204, 205) and extend from the equipment 120 to the PDU 100 by way of the aperture 710. The covering 720 forms a protective seal around the electrical leads 114a-e to protect the interior of the PDU enclosure 600.

Several safety features may be included in various embodiments of the PDU enclosure 600. One safety feature is a visual indicator that the PDU enclosure 600 is receiving power similar to the indicator light 210 previously described for the PDU 100. Examples include an LED to indicate power, or a rotating light affixed to the outer surface of the PDU enclosure 600 that activates when power is received by the PDU 100. Another alternative is an audible alarm. This safety feature could indicate when the PDU 100 is receiving power, or alternatively indicate when the PDU 100 begins to receive power. An alternative audible alarm may be activated when the lid 740 is opened to alert the user when the lid 740 of the PDU enclosure 600 is opened and exposing the output connectors (201, 202, 203, 204, and 205) while carrying power. Alternatively, the alarm may be set to sound with or without power in the PDU enclosure 600. Warning labels may be placed to provide further warning.

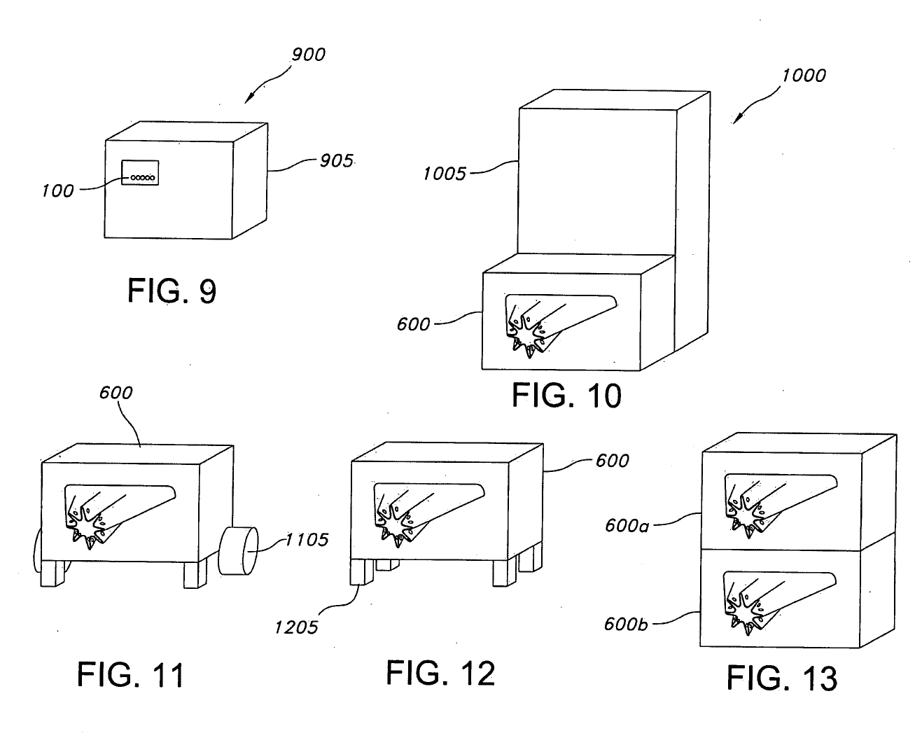

PDUs 100 may be made to facilitate eases of installation or mobility in remote locations. Several alternatives exist. FIG. 9 is a perspective view of an exemplary embodiment of a generator installed PDU 900 where the PDU 100 is incorporated with a generator 905. FIG. 10 is a perspective view of a generator mounted PDU enclosure 1000 where a PDU enclosure 600 is attached to a generator 1005 according to an exemplary embodiment. In the exemplary embodiment, the PDU enclosure 600 may be affixed to a generator 1005, making a combined unit where the combined unit involves two separate devices that are physically connected to each other.

PDU enclosures 600 may also be made to facilitate ease of transport. FIG. 11 is a perspective view a PDU enclosure 600 with attached one or more wheels 1105 according to an exemplary embodiment. This configuration of the PDU enclosure 600 allows it to be mobile. Embodiments may make use of wheels or other methods known to those skilled in the art to facilitate transportation. Such example could be pulled or transported on vehicles.

PDU enclosures 600 may also come in embodiments with different physical features. FIG. 12 is a perspective view of a PDU enclosure 600 with removable legs 1205 according to an exemplary embodiment. The removable legs 1205 may be removable to allow stacking of the PDU enclosures 600. FIG. 13 is a perspective view of a PDU enclosure 600a stacked on top of another PDU enclosure 600b according to an exemplary embodiment.

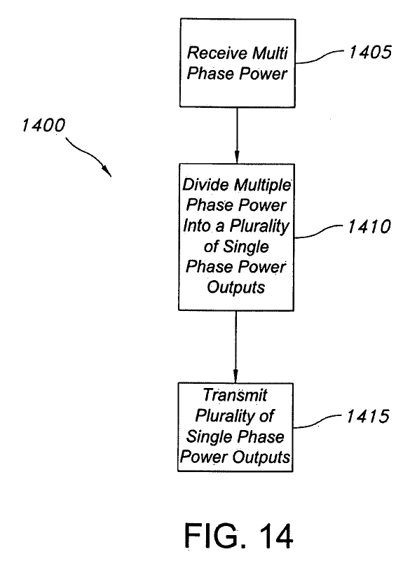

FIG. 14 is a flowchart depicting a method 1400 for distributing power via a the PDU 100 according to an exemplary embodiment. The method 1400 utilized by the above disclosed apparatus may be practiced in various formats without departing form the scope and spirit of the invention. The method 1400 comprises receiving multiple phase power from a power source 110 as illustrated in step 1405. Once the multiple phase power has been received, the multiple phase power is divided into the single phase, neutral, and ground output connectors 201-205 as illustrated in step 1410. Then, the multiple outputs may be transmitted to equipment 120 as illustrated at step 1415.

As described herein, the present invention is well adapted to attain the ends and advantages mentioned, as well as those inherent therein. The particular embodiments above are illustrative only, as the present invention may be modified and practiced in different but equivalent manners apparent to those having ordinary skill in the art and having the benefit of the teachings provided herein. Having described some exemplary embodiments of the present invention, the use of alternate input connectors or output connectors is within the purview of those having ordinary skill in the art.

Any spatial references herein, such as, for example, “top,” “bottom,” “upper,” “lower,” “above,” “below,” “rear,” “between,” “vertical,” “angular,” “beneath,” etc., are for the purpose of illustration only and do not limit the specific orientation or location of the described structure.

While numerous changes may be made by those having ordinary skill in the art, such changes are encompassed within the spirit and scope of the invention as defined by the appended claims. Furthermore, no limitations are intended to the exemplary details of construction or design herein shown, other than as described in the claims below. It is therefore evident that the particular illustrative embodiments disclosed above may be altered or modified and all such variations are considered within the scope and spirit of the present invention. The terms in the claims have their plain, ordinary meaning unless otherwise explicit and clearly defined by the patentee.

What is claimed is:

1. A power distribution unit, comprising:
an input connector; and
at least one output connector,
wherein said input connector and said at least one output connector are electrically coupled,
wherein said input connector receives power in more than one phase, and
wherein said at least one output connector transmits the power in one phase.

2. The power distribution unit of claim 1, further comprising:
at least one electrical coupling between said input connector and one or more of said at least one output connector,
wherein said at least one electrical coupling separates said power into a plurality of single phase power outputs, and
wherein one of each of said plurality of single phase power outputs is electrically coupled to a corresponding one of said at least one output connector.

3. The power distribution unit of claim 1, further comprising a light that indicates when said power distribution unit is receiving said power.

4. The power distribution unit of claim 1, further comprising an audible alarm that indicates when said power distribution unit is receiving said power.

5. The power distribution unit of claim 1, wherein said at least one output connector is a split stud connector.

6. The power distribution unit of claim 1, further comprising a housing.

7. A power distribution component, comprising:
an enclosure; and
a power distribution unit disposed within said enclosure and comprising
an input connector, and
at least one output connector,
wherein said at least one input connector and said at least one output connector are electrically coupled;
wherein said input connector receives power in more than one phase; and
wherein said output connector transmits the: power in one phase.

8. The power distribution component of claim 7, wherein said at least one output connector is accessible through an external surface of said power distribution component.

9. The power distribution component of claim 7, wherein said enclosure comprises a coverable opening to allow access to an interior of said power distribution component.

10. The power distribution component of claim 9, wherein said at least one output connector is accessible when said sealable opening is in an open position.

11. The power distribution component of claim 1, wherein said enclosure further comprises an aperture allowing at least one electrical lead to connect between said at least one output connector and an external device.

12. The power distribution component of claim 11, wherein said aperture contains a covering that protects an interior of said power distribution component.

13. The power distribution component of claim 7, wherein said enclosure comprises at least one connector coupled to said enclosure.

14. The power distribution component of claim 7, further comprising:
a power source affixed directly to said enclosure; and
wherein said power source is electrically coupled to said at least one input connector.

15. The power distribution component of claim 7, wherein said enclosure comprises at least one leg.

16. The power distribution component of claim 7, wherein said power distribution component is stackable upon a second power distribution component.

17. The power distribution component of claim 7, wherein the power distribution unit further comprises:
at least one electrical coupling between said at least one input connector and one or more said at least one output connector;
wherein said at least one electrical coupling separates said power into a plurality of single phase power outputs; and
wherein one of each said plurality of single phase power outputs is transmitted by one of said at least one output connector.

18. The power distribution component of claim 7, further comprising a light that indicates when said power distribution unit is receiving said power.

19. The power distribution component of claim 7, further comprising an audible alarm that indicates when said power distribution unit is receiving said power.

20. The power distribution component of claim 7, wherein said at least one output connector is a split stud connector.

21. A method of distributing power, comprising:
receiving power in multiple electrical phases;
dividing said power into a plurality of single phase electrical power outputs; and
transmitting said plurality of single phase electrical power outputs.
